(19) United States
(12) Patent Application Publication
(10) Pub. No.: US 2026/0261066 A1
(43) Pub. Date: Sep. 3, 2026

(54) Connector

(71) Applicant: Tyco Electronics (Shanghai) Co., Ltd., Shanghai (CN)

(72) Inventors: Tommy Qian, Shanghai (CN); Xiao (Nichee) Zhou, Shanghai (CN); Yuchen Yang, Shanghai (CN); Xinquan (Jone) Ji, Shanghai (CN)

(73) Assignee: Tyco Electronics (Shanghai) Co., Ltd., Shanghai (CN)

(21) Appl. No.: 19/554,937

(22) Filed: Mar. 3, 2026

(30) Foreign Application Priority Data
Mar. 3, 2025 (CN) 202510246289.3

(51) Int. Cl. H01R 13/42; H01R 4/56; H01R 13/506; H01R 13/52; H01R 25/16; H01R 43/20

(52) U.S. Cl. CPC H01R 13/42; H01R 4/56; H01R 13/506; H01R 13/5202; H01R 25/161; H01R 43/20

(57) ABSTRACT

A connector includes an insulation housing having an insertion slot receiving a busbar along a longitudinal direction, and a terminal assembly installed in the insulation housing. The terminal assembly is held in a pre-installed position that does not interfere with insertion of the busbar before the busbar is inserted into the insulation housing. After the busbar is inserted into the insulation housing, the terminal assembly is movable from the pre-installed position to a final installed position along a height direction perpendicular to the longitudinal direction. The terminal assembly is electrically connected to the busbar in the final installed position.

### CROSS-REFERENCE TO RELATED APPLICATION

This application claims the benefit of the filing date under 35 U.S.C. § 119(a)-(d) of Chinese Patent Application No. CN 202510246289.3, filed on Mar. 3, 2025.

### FIELD OF THE INVENTION

The present invention relates to a connector.

### BACKGROUND OF THE INVENTION

A right angle connector used to achieve a right angle connection typically includes an insulation housing, a horizontal terminal, a vertical terminal, and a threaded connection member. The horizontal and vertical terminals are set in the insulation housing and fastened together by a threaded connection member. The horizontal terminal extends horizontally and is used for electrical connection with the busbar of the client. The vertical terminal extends along the height direction and is used for electrical connection with the connection terminal at the cable end. The cost of this right angle connector is relatively high because it requires the use of two terminals that are perpendicular to each other; a horizontal terminal and a vertical terminal.

### SUMMARY OF THE INVENTION

A connector includes an insulation housing having an insertion slot receiving a busbar along a longitudinal direction, and a terminal assembly installed in the insulation housing. The terminal assembly is held in a pre-installed position that does not interfere with insertion of the busbar before the busbar is inserted into the insulation housing. After the busbar is inserted into the insulation housing, the terminal assembly is movable from the pre-installed position to a final installed position along a height direction perpendicular to the longitudinal direction. The terminal assembly is electrically connected to the busbar in the final installed position.

### BRIEF DESCRIPTION OF DRAWINGS

The invention will now be described by way of example with reference to the accompanying figures, of which:

FIG. 1 is a perspective view of a connector according to an exemplary embodiment;

FIG. 2 is a longitudinal sectional view of the connector of FIG. 1;

FIG. 3 is an exploded view of the connector of FIG. 1;

FIG. 4 is an exploded view of an insulation housing of the connector of FIG. 1;

FIG. 5 is another exploded view of the insulation housing of FIG. 4;

FIG. 6 is a longitudinal sectional view of the connector of FIG. 1, where a busbar of the client has not yet been inserted into the connector and terminal assemblies of the connector are held in a pre-installed position;

FIG. 7 is a longitudinal sectional view of the connector of FIG. 1, where the busbar of the client of FIG. 6 has been inserted into the connector and at least one of the terminal assemblies of FIG. 6 is in a pre-installed position;

FIG. 8 is a longitudinal sectional view of the connector of FIG. 1, where the busbar of the client of FIG. 6 has been inserted into the connector and at least one of the terminal assemblies of FIG. 6 has been moved to a final installed position electrically connected to the busbar;

FIG. 9 is a longitudinal sectional view of a connector according to an exemplary embodiment, where an elastic block supporting a terminal assembly is in a pre-installed position;

FIG. 10 is a longitudinal sectional view of the connector of FIG. 9, in which the elastic block of FIG. 9 is pushed by an inserted busbar to an avoidance position that does not interfere with the terminal assembly of FIG. 9;

FIG. 11 is a longitudinal sectional view of a connector according to another exemplary embodiment, where a first spring supporting a terminal assembly in a pre-installed position is shown;

FIG. 12 is a longitudinal sectional view of the connector of FIG. 11, in which the first spring of FIG. 11 is pushed by an inserted busbar to an avoidance position that does not interfere with the terminal assembly of FIG. 11;

FIG. 13 is a longitudinal sectional view of a connector according to another exemplary embodiment, where a second spring supporting a terminal assembly in a pre-installed position is shown;

FIG. 14 is a longitudinal sectional view of the connector of FIG. 13, in which the second spring of FIG. 13 is pushed by an inserted busbar to an avoidance position that does not interfere with the terminal assembly of FIG. 13; and

FIG. 15 is a longitudinal sectional view of a connector according to another exemplary embodiment, where a third spring supporting a terminal assembly in a pre-installed position is shown.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

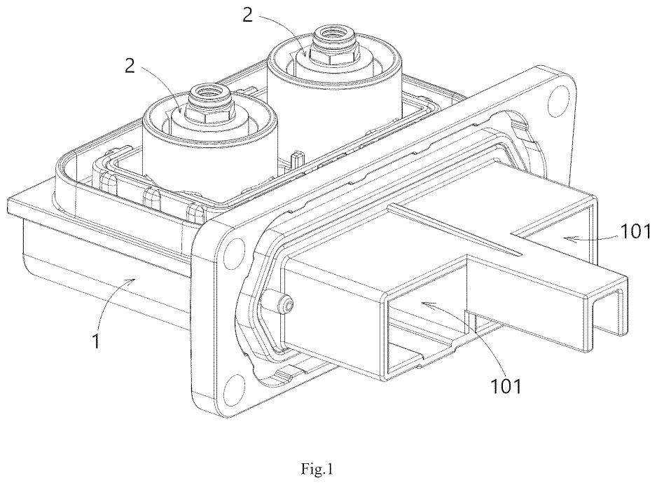

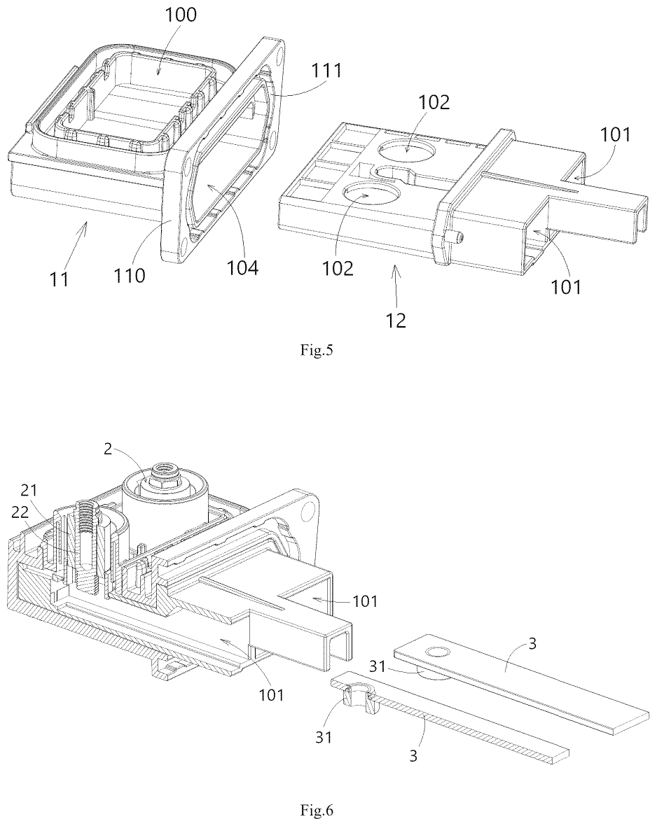

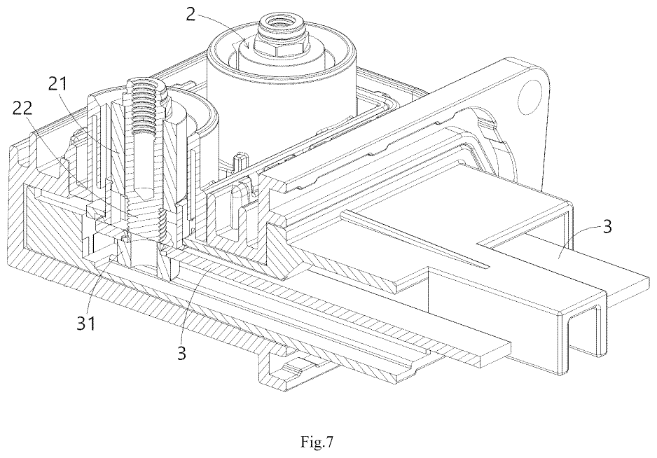

An exemplary embodiment of a connector will now be described with reference to FIGS. 1-10. As shown in FIG. 1, the connector includes an insulation housing 1 and a terminal assembly 2. The insulation housing 1 has an insertion slot 101, as shown in FIGS. 1-6, that allows a busbar 3, as shown in FIGS. 6-8, to be inserted along the longitudinal direction Y. the terminal assembly 2 is installed into the insulation housing 1. Before inserting the busbar 3 into the insulation housing 1, the terminal assembly 2 is held in a pre-installed position, as shown in FIGS. 6-7, that does not interfere with the insertion of the busbar 3. After inserting the busbar 3 into the insulation housing 1, the terminal assembly 2 can be moved from the pre-installed position to a final installed position, as shown in FIG. 8, where it is electrically connected to the busbar 3, along the height direction Z perpendicular to the longitudinal direction Y.

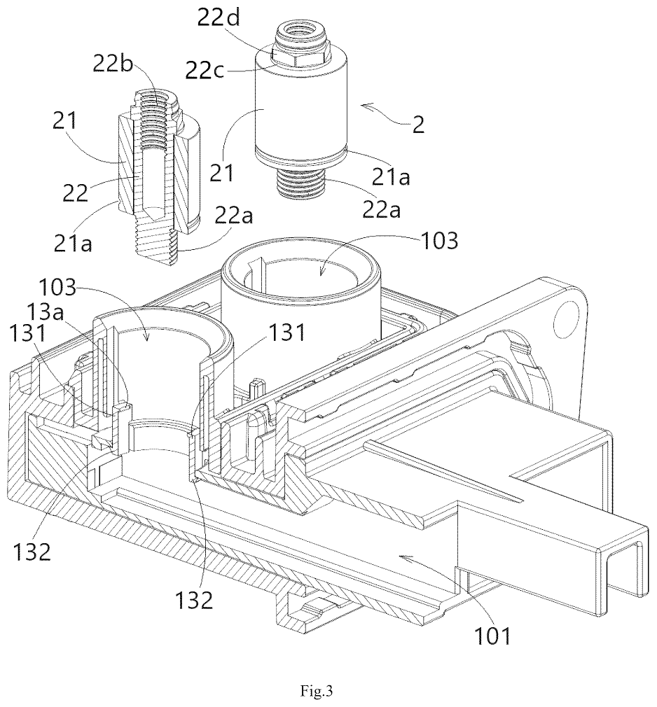

As shown in FIG. 3, a slot 21a is formed on one of the terminal assembly 2 and the insulation housing 1, and an elastic buckle 131 is formed on the other. When the terminal assembly 2 is in the pre-installed position, the slot 21a engages with the elastic buckle 131 to keep the terminal assembly 2 in the pre-installed position.

If the terminal assembly 2 is accidentally moved to the final installed position before the busbar 3 of the client is inserted into the insertion slot 101 of the insulation housing 1, the busbar 3 of the client cannot be inserted into the insertion slot 101 of the insulation housing 1. In order to prevent this situation from occurring, the connector also includes an elastic component 4, which is set in the insertion slot 101 of the insulation housing 1 to support the terminal assembly 2 in the pre-installed position, to prevent the terminal assembly 2 from being accidentally moved to the final installed position before inserting the busbar 3. The elastic component 4 is adapted to be moved from a supporting position of supporting the terminal assembly 2 to an avoidance position that does not interfere with the terminal assembly 2 under the push of the inserted busbar 3, to allow the terminal assembly 2 to be moved from the pre-installed position to the final installed position.

Various different embodiments of the elastic component 4 will now be described with references to FIGS. 9-15. Other than the differences between each elastic component 4, the different embodiments of the connector have the same elements as the connector according to FIGS. 1-8.

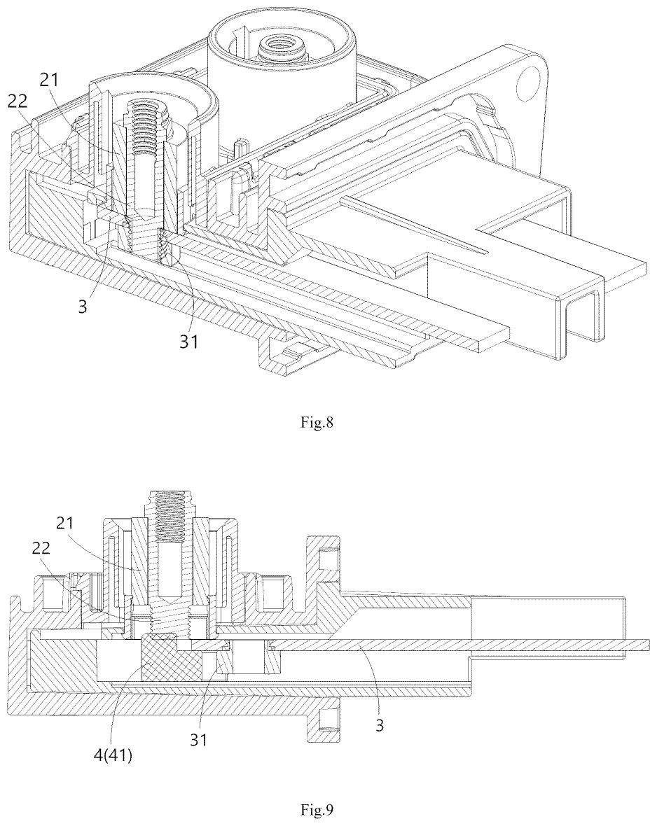

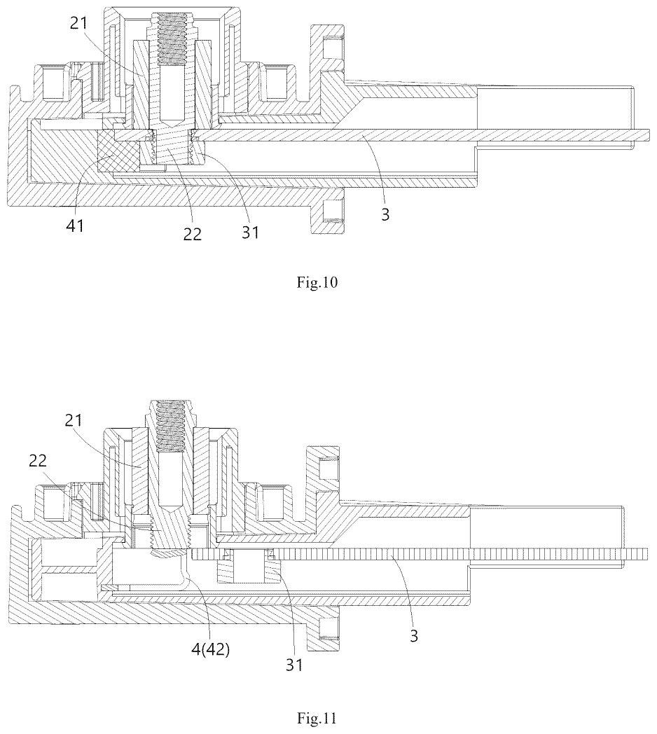

An embodiment of the elastic component 4, as shown in FIGS. 9-10, is an elastic block 41. After the busbar 3 is inserted into the insulation housing 1, the elastic block 41 is pushed and compressed by the busbar 3 to the avoidance position not interfering with the terminal assembly 2.

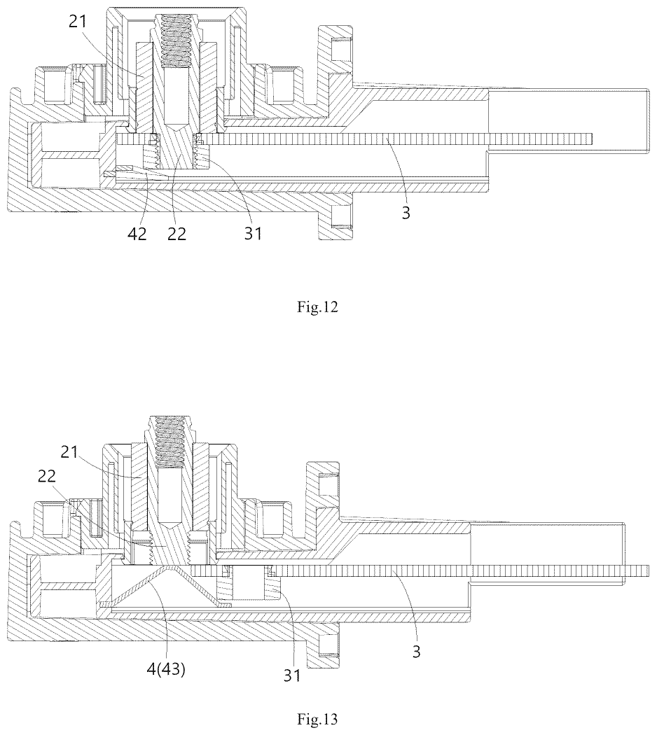

An embodiment of the elastic component 4, as shown in FIGS. 11-12, is a first spring 42, which is Z-shaped or U-shaped, with one end fixed to the insulation housing 1 and the other end supported on the terminal assembly 2. The first spring 42 may be a snap spring. After inserting the busbar 3 into the insulation housing 1, the first spring 42 is pushed and compressed by the busbar 3 to the avoidance position that does not interfere with the terminal assembly 2.

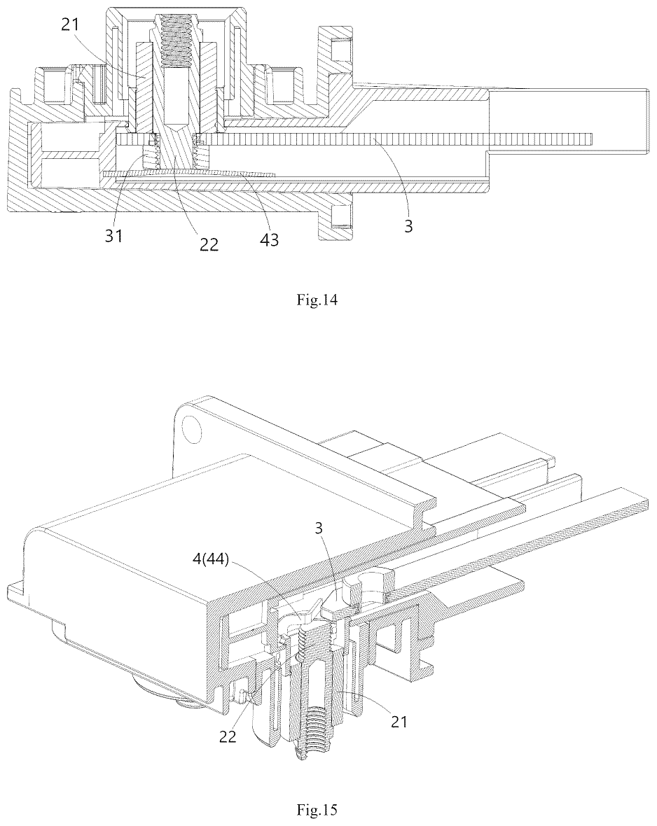

An embodiment of the elastic component 4, as shown in FIGS. 13-14, is a second spring 43, which is adapted to undergo elastic deformation along the height direction Z under the pushing and compressing of the inserted busbar 3. The second spring 43 may be a snap spring. The second spring 43 is V-shaped, with one end fixed to the insulation housing 1 and the other end slidably supported on the inner wall of the insertion slot 101 or suspended in the insertion slot 101. The top of the second spring 43 is supported on the terminal assembly 2. After inserting the busbar 3 into the insulation housing 1, the second spring 43 is pushed and compressed by the busbar 3 to the avoidance position that does not interfere with the terminal assembly 2.

An embodiment of the elastic component 4, as shown in FIG. 15, is a third spring 44, which is adapted to undergo elastic deformation along the transverse direction X under the pushing and compressing of the inserted busbar 3. The third spring 44 may be a snap spring. The third spring 44 is V-shaped, with one end fixed to the insulation housing 1 and the other end slidably supported on the inner wall of the insertion slot 101 or suspended in the insertion slot 101. The top of the third spring 44 is supported on the terminal assembly 2. After inserting the busbar 3 into the insulation housing 1, the third spring 44 is pushed and compressed by the busbar 3 to the avoidance position that does not interfere with the terminal assembly 2.

The embodiments of the connector according to FIGS. 1-15 do not have a horizontal terminal extending longitudinally. Therefore, the present invention reduces the number of terminals in each embodiment of the connector and lowers costs. In the present invention, the insulation housing 1 of each embodiment of the connector has an insertion slot 101 that allows the busbar 3 of the client to be inserted along the longitudinal direction Y, and the terminal assembly 2 of each embodiment of the connector can be fastened to the inserted busbar 3 along the height direction Z, thereby facilitating electrical connection between each embodiment of the connector and the busbar 3 of the client.

In addition, the terminal assembly 2 of each embodiment of the connector can be reliably held in a pre-installed position that does not interfere with the insertion of the respective busbar 3 before the respective busbar 3 of the client is inserted into the insertion slot 101 of each embodiment of the connector, thereby ensuring that the respective busbar 3 of the client can be smoothly inserted into the insertion slot 101 of each embodiment of the connector.

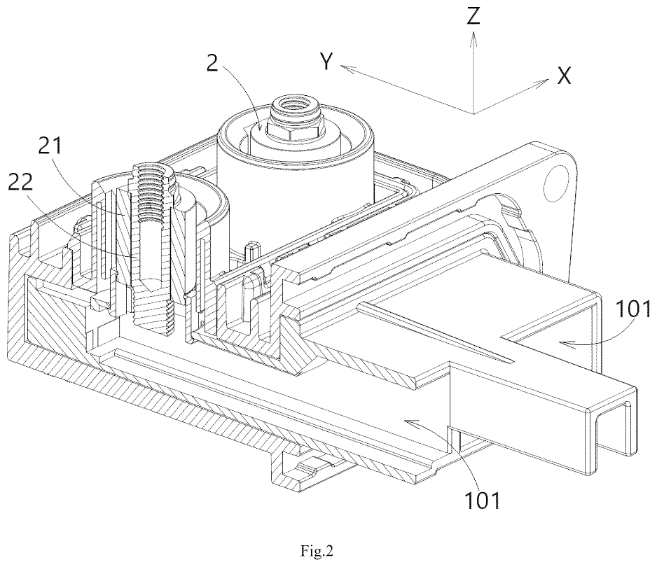

The terminal assembly 2 of each embodiment of the connector, as shown in FIGS. 2-3 and 6-15, includes a terminal 21 and a connecting member 22. Each terminal 21 is cylindrical in shape extending along the height direction Z. Each connecting member 22 passes axially through a respective terminal 21. Each connecting member 22 is suitable for threaded connection with a respective nut 31 on the respective inserted busbar 3, as shown in FIGS. 6-14, and is used to drive the respective terminal assembly 2 to move from the pre-installed position to the final installed position. Each nut 31 on the respective busbar 3 is usually riveted or welded to one end of respective busbar 3.

As shown in FIGS. 9, 11, 13, and 15, when each respective elastic component 4 is in the pre-installed position and the respective busbar 3 is not inserted into the insulation housing 1, each elastic component 4 is supported on the lower end surface of the respective connecting member 22 to support the respective terminal assembly 2 in the pre-installed position.

After the respective busbar 3 is inserted into the respective insulation housing 1 and the respective terminal assembly 2 is in the pre-installed position, the respective terminal 21 does not contact the respective busbar 3. After inserting the respective busbar 3 into the respective insulation housing 1 and moving the respective terminal assembly 2 to the final installed position, the respective terminal 21 is fastened to the respective busbar 3 by the respective connecting member 22.

As shown in FIG. 3, a circular slot 21a is formed on the outer peripheral surface of the terminal 21, and multiple elastic buckles 131 are formed in the insulation housing 1, which are distributed around the terminal 21 at intervals. A protrusion 13a is formed on the elastic buckle 131, and the protrusions 13a of multiple elastic buckles 131 are suitable for being engaged into the slot 21a of the terminal 21 to hold the terminal assembly 2 in the pre-installed position.

As shown in FIG. 3, the connecting member 22 is cylindrical in shape extending along the height direction Z and has axially opposite upper and lower ends. An external thread 22a, as shown in FIG. 3, is formed on the lower end of the connecting member 22 for threaded connection with the nut 31 on the busbar 3. A positioning flange 22c, as shown in FIG. 3, is formed on the outside of the upper end of the connecting member 22, and the terminal 21 is suitable for being axially clamped and fixed between one end of the respective busbar 3 and the positioning flange 22c of the connecting member 22.

The terminal 21 of each embodiment of the connector has a lower end face for electrical contact with the respective busbar 3 and an upper end face for electrical contact with a respective connecting terminal. A threaded hole 22b, as shown in FIG. 3, is formed in the upper end of the connecting member 22, so that the connecting terminal can be fastened to the upper end face of the terminal 21 through a bolt connected to the threaded hole 22b.

A tool engagement part 22d, as shown in FIG. 3, suitable for engagement with an operating tool is formed on the outside of the upper end of the connecting member 22, so that the connecting member 22 can be tightened or loosened by the operating tool engaged with the tool engagement part 22d. In the illustrated embodiment, the tool engagement part 22d is hexagonal in shape.

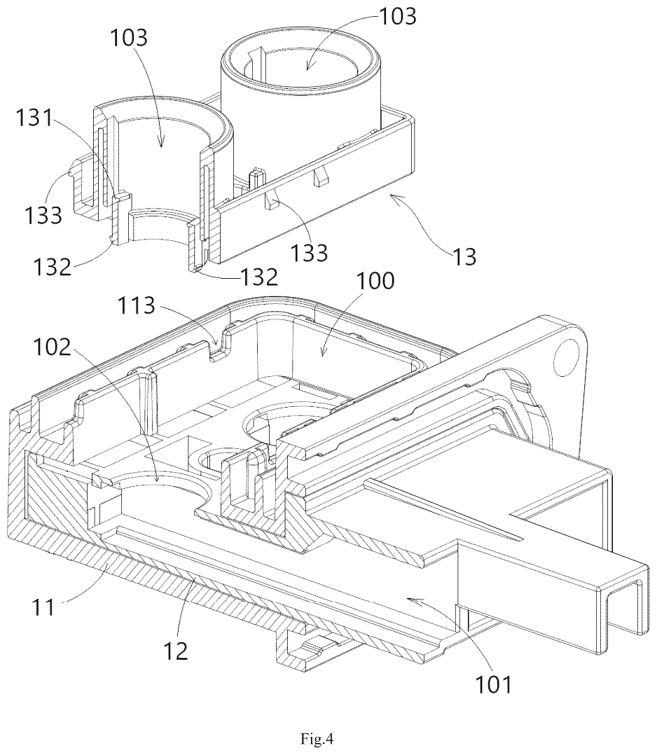

As shown in FIG. 4, the insulation housing 1 includes an outer housing 11, an inner housing 12, and an insulator 13. As shown in FIG. 5, the outer housing 11 has a front end wall and a rear port 104 that are opposite in the longitudinal direction Y, and a bottom wall and a top mounting port 100 that are opposite in the height direction Z. The inner housing 12 is inserted into the outer housing 11 through the rear port 104. The insulator 13 is installed into the top mounting port 100 of the outer housing 11. As shown in FIG. 4, a socket 103 extending along the height direction Z is formed in the insulator 13, and an insertion slot 101 extending along the longitudinal direction Y and a top opening 102 connecting the socket 103 and the insertion slot 101 are formed in the inner housing 12. The terminal assembly 2 is installed into the socket 103 of the insulator 13 and is adapted to enter the insertion slot 101 through the top opening 102 for electrical connection with the busbar 3 inserted into the insertion slot 101.

As shown in FIG. 3, a circular slot 21a is formed on the outer peripheral surface of the terminal 21, and multiple elastic buckles 131 are formed in the socket 103 of the insulator 13, which are distributed around the terminal 21 at intervals. A protrusion 13a is formed on the elastic buckle 131, and the protrusions 13a of multiple elastic buckles 131 are suitable for being engaged into the slot 21a of the terminal 21 to hold the terminal assembly 2 in the pre-installed position.

As shown in FIG. 3, multiple buckles 132 are formed at intervals around the socket 103 at the bottom of the insulator 13. The multiple buckles 132 are inserted into the top opening 102 of the inner housing 12 and engaged with the edge of the top opening 102 to lock the insulator 13 to the inner housing 12.

As shown in FIG. 4, multiple spaced positioning slots 113 are formed on the peripheral wall of the top mounting port 100 of the outer housing 11, and multiple spaced positioning protrusions 133 are formed on the outer peripheral surface of the insulator 13. The multiple positioning protrusions 133 are respectively engaged into the multiple positioning slots 113 to position the insulator 13 into the top mounting port 100.

As shown in FIGS. 1-6, multiple insertion slots 101 arranged side by side in the transverse direction X are formed in the inner housing 12. Multiple sockets 103 corresponding to the multiple insertion slots 101 are formed in the insulator 13. The connector includes multiple terminal assemblies 2 respectively installed into multiple sockets 103, which are used to electrically connect with multiple busbars 3 respectively inserted into multiple sockets 103.

A flange part 110, as shown in FIG. 5, for fixing to an installation panel is formed at the rear end of the outer housing 11, and a sealing ring installation groove 111, as shown in FIG. 5, is formed on the flange part 110 around the rear port 104 of the outer housing 11. The connector also includes a sealing ring, which is installed into the sealing ring installation groove 111. The sealing ring is suitable for being compressed between the flange part 110 of the outer housing 11 and the installation panel to achieve sealing between the two.

The rear end of the inner housing 12 extends from the rear port 104 of the outer housing 11 and is adapted to be inserted into an opening on the installation panel.

In the aforementioned exemplary embodiments according to the present invention, the connector does not have a horizontal terminal extending longitudinally, thus reducing the number of terminals in the connector and lowering costs. In the present invention, the insulation housing 1 of the connector has an insertion slot 101 that allows the client's busbar 3 to be inserted longitudinally, and the terminal assembly 2 of the connector can be fastened to the inserted busbar 3 along the height direction, thereby facilitating electrical connection between the connector and the client's busbar 3.

In addition, in the aforementioned exemplary embodiments of the present invention, the terminal assembly 2 of the connector can be reliably held in a pre-installed position that does not interfere with the insertion of the busbar 3 before the busbar 3 of the client is inserted into the insertion slot 101 of the connector, thereby ensuring that the busbar 3 of the client can be smoothly inserted into the insertion slot 101 of the connector.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector, comprising:
an insulation housing having an insertion slot receiving a busbar along a longitudinal direction; and
a terminal assembly installed in the insulation housing, the terminal assembly is held in a pre-installed position that does not interfere with insertion of the busbar before the busbar is inserted into the insulation housing, and after the busbar is inserted into the insulation housing, the terminal assembly is movable from the pre-installed position to a final installed position along a height direction perpendicular to the longitudinal direction, the terminal assembly is electrically connected to the busbar in the final installed position.

2. The connector of claim 1, wherein a slot is formed on one of the terminal assembly and the insulation housing, and an elastic buckle is formed on the other of the terminal assembly and the insulation housing, the slot engages with the elastic buckle to hold the terminal assembly in the pre-installed position when the terminal assembly is in the pre-installed position.

3. The connector of claim 1, further comprising an elastic component installed in the insertion slot to support the terminal assembly in the pre-installed position, the elastic component prevents the terminal assembly from being accidentally moved to the final installed position before the busbar is inserted.

4. The connector of claim 3, wherein the elastic component is movable from a support position supporting the terminal assembly to an avoidance position that does not interfere with the terminal assembly under a push of the busbar, the terminal assembly is movable from the pre-installed position to the final installed position with the elastic component in the avoidance position.

5. The connector of claim 4, wherein the elastic component is an elastic block, the elastic block is pushed and compressed to the avoidance position by the busbar after the busbar is inserted into the insulation housing.

6. The connector of claim 4, wherein the elastic component is a first spring, the first spring is Z-shaped or U-shaped, an end of the first spring is fixed to the insulation housing and another end of the first spring is supported on the terminal assembly, after the busbar is inserted into the insulation housing, the first spring is pushed and compressed by the busbar to the avoidance position.

7. The connector of claim 4, wherein the elastic component is a second spring, the second spring undergoes elastic deformation along the height direction under the pushing and compressing of the busbar, the second spring is V-shaped, an end of the second spring is fixed to the insulation housing and another end of the second spring is slidably supported on an inner wall of the insertion slot or suspended in the insertion slot, a top of the second spring is supported on the terminal assembly, after the busbar is inserted into the insulation housing, the second spring is pushed and compressed by the busbar to the avoidance position.

8. The connector of claim 4, wherein the elastic component is a third spring, the third spring is elastically deformed along a transverse direction under the pushing and compressing of the busbar, the third spring is V-shaped, an end of the third spring is fixed to the insulation housing and another end of the third spring is slidably supported on an inner wall of the insertion slot or suspended in the insertion slot, a top of the third spring is supported on the terminal assembly, after the busbar is inserted into the insulation housing, the third spring is pushed and compressed by the busbar to the avoidance position.

9. The connector of claim 3, wherein the terminal assembly includes a terminal and a connecting member, the terminal has a cylindrical shape extending along the height direction, the connecting member axially passes through the terminal, the connecting member is threadably connected with a nut on the busbar and drives the terminal assembly to move from the pre-installed position to the final installed position, and when the elastic component is in the pre-installed position and the busbar is not inserted into the insulation housing, the elastic component is supported on a lower end surface of the connecting member to support the terminal assembly in the pre-installed position.

10. The connector of claim 9, wherein, after the busbar is inserted into the insulation housing and the terminal assembly is in the pre-installed position, the terminal is not in contact with the busbar, and after the busbar is inserted into the insulation housing and the terminal assembly is moved to the final installed position, the terminal is fastened to the busbar by the connecting member.

11. The connector of claim 9, wherein a circular slot is formed on an outer peripheral surface of the terminal, and a plurality of elastic buckles are formed in the insulation housing, the elastic buckles are distributed around the terminal at intervals, a protrusion is formed on each elastic buckle, the protrusion of each elastic buckle engages into a slot of the terminal to hold the terminal assembly in the pre-installed position.

12. The connector of claim 11, wherein the connecting member has a cylindrical shape extending along the height direction and has axially opposite upper and lower ends, an external thread is formed on a lower end of the connecting member for threaded connection with the nut on the busbar, a positioning flange is formed on an outside of an upper end of the connecting member, the terminal is axially clamped and fixed between one end of the busbar and the positioning flange of the connecting member.

13. The connector of claim 12, wherein the terminal has a lower end face for electrical contact with the busbar and an upper end face for electrical contact with a connecting terminal, a threaded hole is formed in the upper end of the connecting member allowing fastening of the connecting terminal to the upper end face of the terminal through a bolt connected to the threaded hole.

14. The connector of claim 12, wherein a tool engagement part engaging with an operating tool is formed on an outside of the upper end of the connecting member, such that the connecting member is tightened or loosened with the operating tool engaging with the tool engagement part.

15. The connector of claim 9, wherein the insulation housing includes an outer housing, an inner housing, and an insulator, the outer housing has a front end wall and a rear port that are opposite in the longitudinal direction, and a bottom wall and a top mounting port that are opposite in the height direction, the inner housing is inserted into the outer housing through the rear port, the insulator is installed into the top mounting port of the outer housing, a socket extending along the height direction is formed in the insulator, and the insertion slot extending along the longitudinal direction and a top opening connecting the socket and the insertion slot are formed in the inner housing, the terminal assembly is installed into the socket of the insulator and enters the insertion slot through the top opening for electrical connection with the busbar inserted into the insertion slot.

16. The connector of claim 15, wherein a circular slot is formed on an outer peripheral surface of the terminal, and a plurality of elastic buckles are formed in the socket of the insulator, the elastic buckles are distributed around the terminal at intervals, a protrusion is formed on each elastic buckle, the protrusion of each elastic buckle engages into the slot of the terminal to hold the terminal assembly in the pre-installed position.

17. The connector of claim 15, wherein a plurality of buckles are formed at intervals around the socket at a bottom of the insulator, each buckle is inserted into the top opening of the inner housing and engage with an edge of the top opening to lock the insulator to the inner housing.

18. The connector of claim 15, wherein a plurality of positioning slots distributed at intervals are formed on a peripheral wall of the top mounting port of the outer housing, and a plurality of positioning protrusions distributed at intervals are formed on an outer peripheral surface of the insulator, each positioning protrusion engages into one positioning slot to position the insulator into the top mounting port.

19. The connector of claim 15, wherein a plurality of insertion slots arranged side by side in a transverse direction are formed in the inner housing, and a plurality of sockets corresponding to the plurality of insertion slots are formed in the insulator, and the connector comprises a plurality of terminal assemblies each installed into one socket, the terminal assemblies electrically connect with a plurality of busbars each inserted into one socket.

20. The connector of claim 15, wherein a flange part fixing to an installation panel is formed at a rear end of the outer housing, and a sealing ring installation groove is formed on the flange part around the rear port of the outer housing, and the connector further comprises a sealing ring installed into the sealing ring installation groove, the sealing ring is compressed between the flange part of the outer housing and the installation panel to achieve sealing between the two, the rear end of the inner housing extends from the rear port of the outer housing and is inserted into an opening on the installation panel.
